(19) United States
(12) Patent Application Publication
(10) Pub. No.: US 2026/0196716 A1
(43) Pub. Date: Jul. 9, 2026

(54) ANTENNA ASSEMBLY

(71) Applicant: Honeywell International Inc., Charlotte, NC (US)

(72) Inventors: Paul SUDHAHAR, Bengaluru (IN); Tirumala Rao KOKA, Chandler, AZ (US); Girish KANAKAGIRI, Tempe, AZ (US); Perumal RAKKIYAGOUNDER, Bengaluru (IN); Madhava GADICHERLA, Bengaluru (IN); Stephane KLANDER, Ottawa (CA)

(21) Appl. No.: 19/057,649

(22) Filed: Feb. 19, 2025

(30) Foreign Application Priority Data
Jan. 3, 2025 (IN) 202511000789

(51) Int. Cl. H01Q 1/28; H01R 13/11

(52) U.S. Cl. CPC H01Q 1/28; H01R 13/11

(57) ABSTRACT

An antenna assembly includes an antenna that has an antenna base, and an adapter plate configured to couple the antenna to a moveable machine. The antenna base may include a plurality of pucks that extend through orifices of the adapter plate. The adapter plate may include a feature that converts an otherwise blunt impact load into a slicing impact load. The adapter plate may include a support wall that extends upward and is aft of the antenna.

### CROSS-REFERENCE TO RELATED APPLICATIONS

The present application claims priority to India Patent Application No. 202511000789, filed January 3, 2025, the contents of which are hereby incorporated herein by reference in its entirety.

### TECHNICAL FIELD

The present application relates generally to antenna assemblies. More specifically, the present application relates to an antenna assembly that prevents an antenna of the antenna assembly from being decoupled from a moveable machine, such as an aircraft, a seacraft, or a land vehicle.

### BACKGROUND

An antenna is a device that converts electrical signals into electromagnetic waves and vice versa, which allows for the transmission and reception of information wirelessly. Antennas often receive or transmit electromagnetic waves to a satellite. Antennas are often coupled to a moveable machine, such as an aircraft, a seacraft, or a land vehicle. Existing antennas are susceptible to being damaged or decoupled from the moveable machine when a bird or bat strikes the moveable machine.

The inventor has identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems, methods, and apparatuses to provide for improved antenna assemblies.

In various aspects, an antenna assembly comprises an antenna comprising an antenna base. The antenna base may comprise a plurality of pucks. The antenna assembly may include an adapter plate configured to couple the antenna to a fuselage of an aircraft. The adapter plate may define a plurality of orifices. Each puck may be positioned within a respective orifice of the plurality of orifices.

In various examples, each of the plurality of orifices extend completely through a thickness of the adapter plate.

In various examples, each of the plurality of orifices have a circular cross-sectional shape.

In various examples, each of the plurality of pucks have a hollow shape that is configured to receive a connector.

In various examples, each of the plurality of pucks have a hollow shape that is configured to receive a Threaded Neill-Concelman (TNC) connector.

In various examples, each orifice extends completely through a thickness of the adapter plate.

In various examples, each puck extends a distance that is at least 90% of a thickness of the adapter plate.

In various examples, the adapter plate comprises a feature at a forward end of the adapter plate, wherein the feature has a triangular cross-sectional shape.

In various examples, the adapter plate comprises a support wall that extends upward from a main body of the adapter plate and is positioned aft of the antenna base.

In various examples, the adapter plate includes a feature at a forward end of the adapter plate, wherein the feature has a triangular cross-sectional shape. The adapter plate may include a support wall that extends upward from a main body of the adapter plate and is positioned aft of the antenna base.

In various aspects, an adapter plate configured to couple an antenna to a fuselage of an aircraft is provided. The adapter plate may include a feature at a forward end of the adapter plate. The feature may be configured to convert an otherwise blunt impact load into a slicing impact load.

In various examples, the feature is a razer edge or a knife edge.

In various examples, the feature has a triangular cross-sectional shape.

In various examples, the feature has a leading edge that is a forward-most portion of the feature and two sides that extend from the leading edge, and wherein an angle between the two sides is less than 90 degrees.

In various examples, the leading edge extends vertically.

In various aspects, an antenna assembly includes an antenna and an adapter plate configured to couple the antenna to a fuselage of an aircraft. The adapter plate may include a main body configured to receive the antenna. The adapter plate may include a support wall extending upward from the main body and configured to be aft of the antenna when the antenna is received by the main body.

In various examples, the support wall extends around an aft end of the antenna at least 120 degrees.

In various examples, the antenna comprises an antenna base. The support wall may extend upward a distance that is at least half a height of the antenna base.

In various examples, an inward-facing vertical surface of the support wall of the adapter plate has a shape that corresponds to an outward-facing vertical surface of the antenna.

In various examples, the antenna comprises a plurality of pucks, the adapter plate defines a plurality of orifices, each puck of the antenna is positioned within a respective orifice of the plurality of orifices of the adapter plate, and the adapter plate comprises a feature at a forward end of the adapter plate, wherein the feature has a triangular cross-sectional shape.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides an isometric view of an antenna assembly coupled to a moveable machine, in accordance with an example embodiment.

FIG. 2 provides an isometric view of an antenna assembly, in accordance with an example embodiment.

FIG. 3 provides an isometric view of a portion of an antenna assembly, in accordance with an example embodiment.

FIG. 4 provides an isometric view of a portion of the antenna assembly of FIG. 3, in accordance with an example embodiment.

FIG. 5 provides a schematic, cross-sectional view of an antenna assembly, in accordance with an example embodiment.

FIG. 6 provides a schematic, cross-sectional view of a portion of the antenna assembly of FIG. 5, in accordance with an example embodiment.

FIG. 7 provides a cross-sectional view of a portion of an antenna assembly, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, terms of approximation, such as “approximately,” “substantially,” or “about,” refer to being within manufacturing or engineering tolerances. For example, terms of approximation may refer to being within a five percent margin of error.

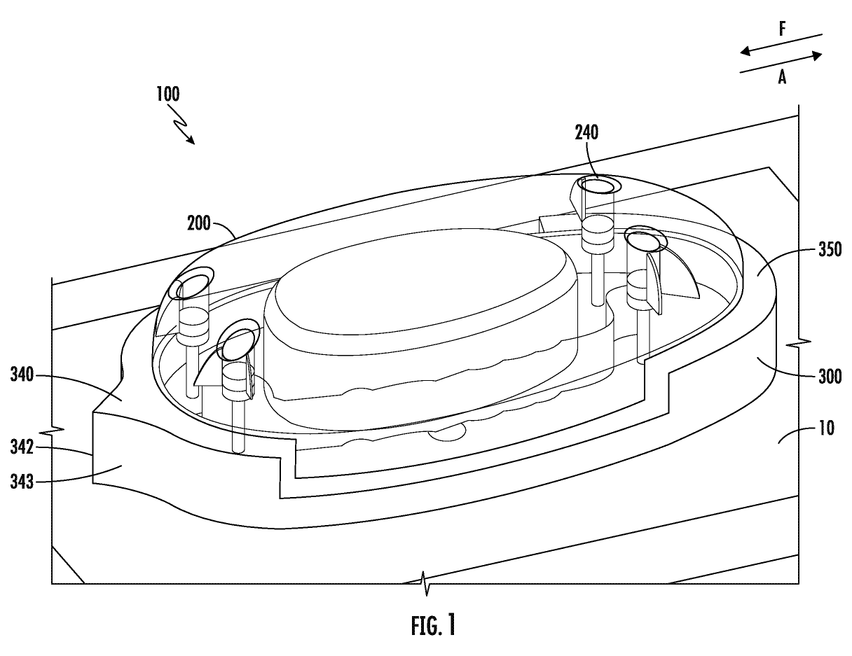

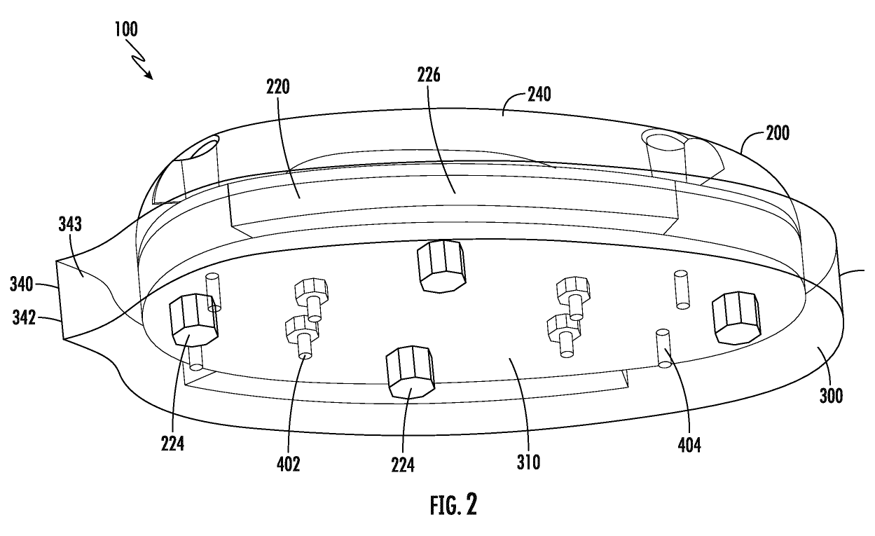

Referring now to FIGS. 1-2, isometric views of at least portions of an antenna assembly 100 are provided, in accordance with an example embodiment. The antenna assembly 100 may be configured to be coupled to a moveable machine. For example, and as depicted in FIG. 1, the antenna assembly 100 may be coupled to the fuselage 10 of an aircraft (e.g., an airplane, a rotorcraft, a spacecraft). The antenna assembly 100 may be configured to be coupled to various other types of moveable machines, such as a seacraft (e.g., a ship) or a land vehicle (e.g., a car, a truck, a train). The antenna assembly 100 may define a forward direction F and an aft direction A.

In various examples, the antenna assembly 100 includes an antenna 200. The antenna 200 may include an antenna base 220 and various electronic components that are configured to or facilitate the conversion of alternating electric current into radio waves, and vice-versa. The antenna 200 may include a radome 240 that is coupled to the antenna base 220. The radome 240 may be dome shaped and may be configured to house and protect the electronic components of the antenna 200 from weather conditions (e.g., rain, sleet, hail, sunlight) or from foreign objects impacting the antenna 200 (e.g., bird or bat strike events).

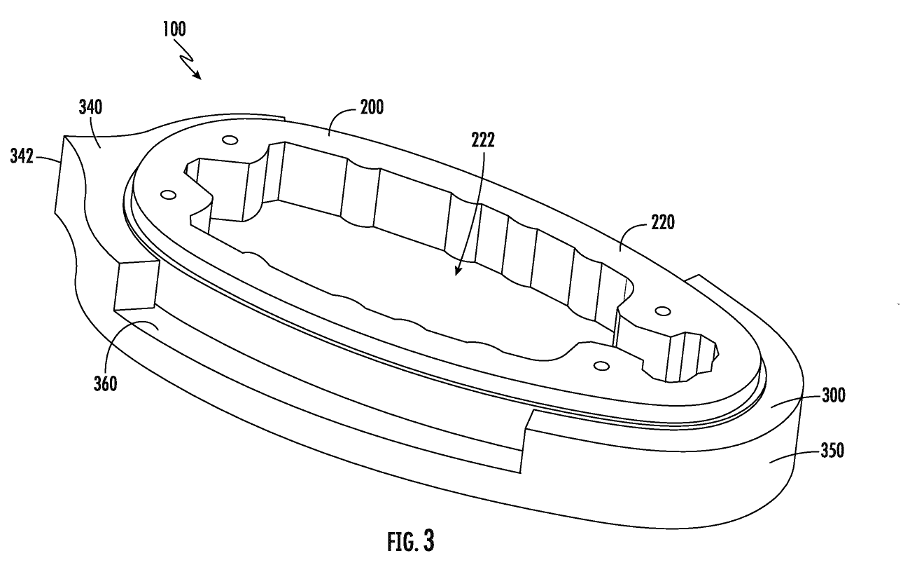

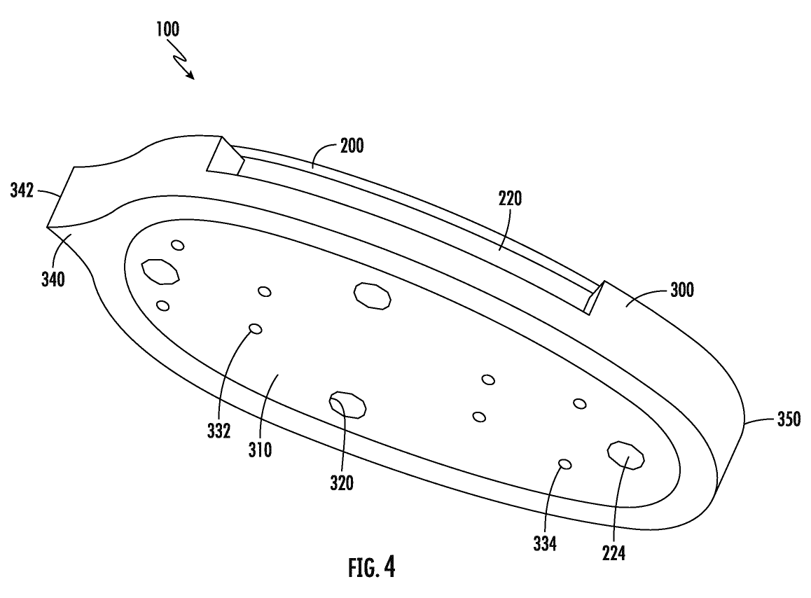

Referring now also to FIGS. 3-4, isometric views of at least portions of an antenna assembly 100 are provided, in accordance with an example embodiment. In various examples, the antenna base 220 may generally have an oval cross-sectional shape. For example, a periphery of the antenna base 220 may be oval shaped. The antenna base 220 may define a cavity 222 that the electronic components of the antenna 200 may be positioned at least partially within.

In various examples, the antenna assembly 100 included an adapter plate 300. The antenna 200 may be coupled to the adapter plate 300. For example, the antenna base 220 of the antenna 200 may be coupled to the adapter plate 300 with at least one fastener 402 (FIG. 2). Each fastener 402 may extend through a hole 332 (FIG. 4) defined by the adapter plate 300 and may be configured as a nut and bolt, as depicted in FIG. 2, a screw, a rivet, or the like. The adapter plate 300 may be configured to couple the antenna 200 to a moveable machine. For example, the antenna 200 may be configured to be coupled to the adapter plate 300, which may be configured to be coupled to the moveable machine, such as configured to be coupled to a fuselage 10 of an aircraft.

In various examples, the adapter plate 300 is configured to be coupled to the moveable machine with at least one fastener 404, which may be configured as a screw, a bolt, a rivet, or the like. For example, the adapter plate 300 may be coupled to a fuselage 10 of an aircraft. Each fastener 404 may extend through a hole 334 (FIG. 4) defined by the adapter plate 300.

In various examples, the antenna base 220 comprises a plurality of pucks 224. Each puck 224 may extend downward from the antenna base 220. For example, each puck 224 may extend orthogonally or substantially orthogonally (e.g., within 5 degrees of orthogonally) from a downward-facing surface of the antenna base 220. A main body 310 of the adapter plate 300, which may have an oval-cross-sectional shape, may define a plurality of orifices 320. Each puck 224 of the antenna base 220 may be positioned at least partially withing a respective orifice 320 of the adapter plate 300. Each orifice 320 may extend completely through or partially through a thickness of the main body 310 of the adapter plate 300. Each puck 224 may extend the complete depth of the respective orifice 320 that it is positioned within. For example, when each orifice 320 extends completely through a thickness of the main body 310 of the adapter plate 300, each puck 224 may extend away from a main body of the antenna base 220 by a distance that is substantially equal to or greater than a thickness of the main body 310 of the adapter plate 300 (e.g., at least 90% of the thickness, such as at least 95% of the thickness of the main body 310 of the adapter plate 300). Each puck 224 may not extend the complete depth of the respective orifice 320 that it is positioned within such that each puck 224 extends away from a main body of the antenna base 220 by a distance that is less than a depth of the respective orifice 320.

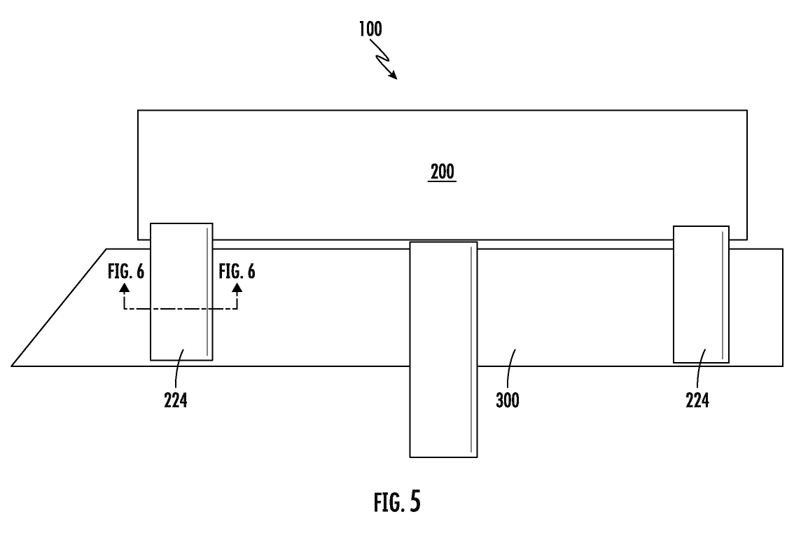

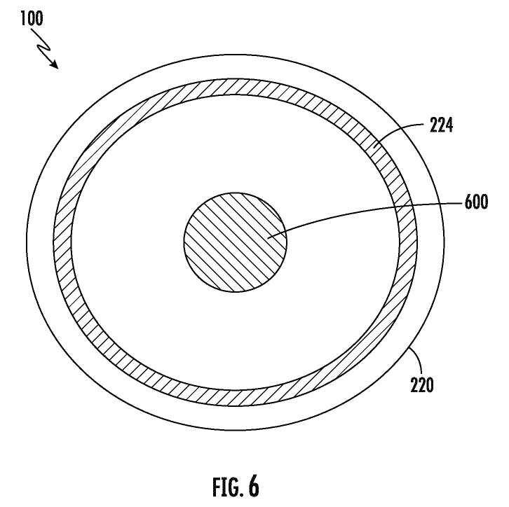

Referring now also to FIGS. 5-6, isometric views of at least portions of an antenna assembly 100 are provided, in accordance with an example embodiment. Each of the plurality of orifices 320 may have a circular cross-sectional shape. Each of the plurality of pucks 224 may have a cylindrical shape that corresponds to a circular cross-sectional shape of the orifice 320 that it is positioned within. For example, each puck 224 may have a diameter that is substantially equal to (e.g., within 5 percent) a diameter of the orifice 320 that it is positioned within. Each orifice 320 and each puck 224 may have any shape. For example, a triangular cross-sectional shape, a semicircle cross-sectional shape, a square cross-sectional shape, etc.

In various examples, each puck 224 has a hollow shape. For example, each puck 224 may have a hollow cylindrical shape, as depicted in FIG. 6. The hollow shape of each puck 224 may be configured to receive a connector 600, such as a Threaded Neill-Concelman (TNC) connector. The connector 600 may be configured to transmit electrical signals to and from the antenna 200.

Providing an antenna 200 with pucks 224 that are positioned within orifices 320 of an adapter plate 300 has several advantages. For example, in the event that the antenna 200 is impacted by an object (e.g., a bird or a bat), the force of the impact that is transferred through the fasteners 402 to the adapter plate 300 may be reduced because some of the force would be transferred to the adapter plate 300 via the pucks 224. Reducing the amount of force that is transferred via the fasteners 402 is beneficial because it reduces the likelihood that the fasteners 402 break or become dislodged from the adapter plate 300, which may cause the antenna 200 to be decoupled from the adapter plate 300 and/or the antenna assembly 100 from be decoupled from the moveable machine.

In various examples, and with reference to FIGS. 1-4, the adapter plate 300 may comprise a feature 340 at a forward end of the adapter plate 300. The feature 340 may be a razer edge or a knife edge. For example, and as depicted, the feature 340 may have a triangular cross-sectional shape that defines a leading edge 342 that is a forward-most portion of the feature 340 and two sides 343 that extend from the leading edge 342. The two sides 343 that extend from the leading edge 342 may extend in the aft direction A and outward (e.g., outward from a longitudinal center). The two sides 343 that extend from the leading edge 342 may define an angle between them that is less than 120 degrees, such as less than 90 degrees. The leading edge 342 may extend vertically, as depicted. The leading edge 342 may extend at an angle that is within 15 degrees, such as within 10 degrees of a vertical direction. For example, the leading edge 342 may extend upward and aft at an angle that is within 15 degrees, such as within 10 degrees of the vertical direction.

The feature 340 may be configured to convert an otherwise blunt impact load into a slicing impact load. A “blunt impact load” is a force applied orthogonally to a surface. For example, without the feature 340, an object that is traveling in the aft direction A relative to the antenna assembly 100 and strikes the forward end of the adapter plate 300 would cause the adapter plate 300 to experience a blunt impact load. The blunt impact may generate stress waves that may propagate through the antenna assembly 100, which may potentially cause internal stress and strains to the antenna 200, or otherwise deform, damage, or decouple the antenna 200 from the moveable machine (e.g., the aircraft). In contrast, a “slicing impact load” occurs when an object (e.g., a bird or a bat) strikes the antenna 200 at an angle (e.g., strikes the leading edge 342 of the feature 340), causing a cutting or slicing action rather than a direct hit. As such, the feature 340 may cause the antenna assembly 100 to experience a slicing impact load in instances where the antenna assembly 100 would experience a blunt impact load without the feature 340.

Providing the feature 340 that converts the impact into a slicing impact load has various benefits. For example, in a blunt impact, the force is distributed over a larger area, leading to compression and potential deformation of the antenna 200. In a slicing impact, the force is concentrated along a leading edge 342 of the feature 340, increasing the likelihood of cutting or shearing the object (e.g., a bird or a bat). The leading edge 342 of the feature 340 may be configured to handle the shear stresses from impact of the object, which may minimize damage to the antenna 200 as compared to a blunt impact.

In various examples, and with reference to FIGS. 1,3 and4, the adapter plate 300 may include a support wall 350 that extends upward and orthogonally from the main body 310 of the adapter plate 300. The support wall 350 may be positioned aft of the antenna 200, such as aft of the antenna base 220 of the antenna 200. The support wall 350 may extend around an aft end of the antenna 200 at least 90 degrees, such as at least 120 degrees (e.g., such as at least 90 degrees, such as at least 120 degrees around a vertically-extending axis). An inward-facing vertical surface of the support wall 350 of the adapter plate 300 may have a shape that corresponds to an outward-facing vertical surface of the antenna base 220 such that the support wall 350 “cups” the antenna base 220. The support wall 350 may extend upward a distance that is at least half a height of the antenna base 220 of the antenna 200. Providing an adapter plate 300 with a support wall 350 may reduce the amount of force transferred to the fasteners 402 that couple the antenna base 220 of the antenna 200 to the adapter plate 300 because the support wall 350 may absorb at least some of the force. Reducing the amount of force that is transferred via the fasteners 402 is beneficial because it reduces the likelihood that the fasteners 402 break or become dislodged from the adapter plate 300, which may cause the antenna 200 to be decoupled from the adapter plate 300.

In various examples, the adapter plate 300 defines a slot 360 (FIG. 3) on each side of the adapter plate 300. The adapter plate 300 may horizontally circumscribe the antenna base 220 in areas other than the slot 360. The antenna base 220 may comprise a flange 226 (FIG. 2) that is positioned within the slot 360. The slot 360 and the flange 226 may have shapes that correspond to each other. For example, the slot 360 and the flange 226 may each have dovetail shapes. The adapter plate 300 may not include the slot 360 and may completely horizontally circumscribe the antenna base 220.

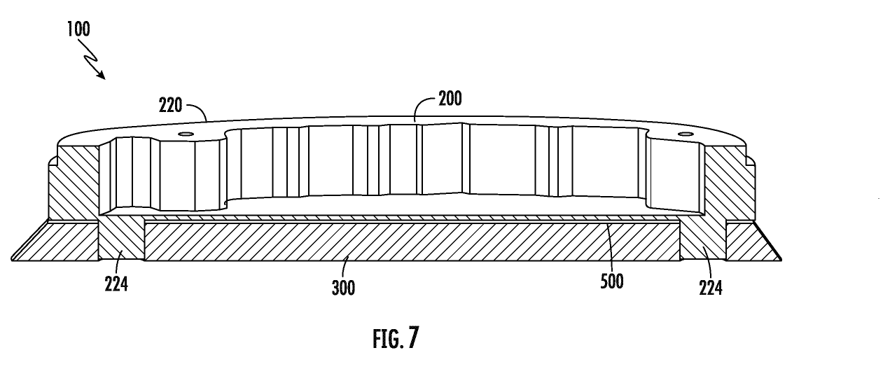

Referring now also to FIG. 7, the antenna assembly 100 may include a shock absorber 500. The shock absorber 500 may be positioned between the antenna base 220 of the antenna 200 and the adapter plate 300. The shock absorber 500 may comprise a shock-absorbing material, such as an elastomer. The shock absorber 500 may be configured to reduce the impact of an object hitting the antenna assembly 100 by dissipating and absorbing kinetic energy. The shock absorber 500 may cover a substantial amount of the surface area of a downward-facing surface of the antenna base 220. For example, the shock absorber 500 may cover at least 70%, such as at least 80%, such as at least 90% of a surface area of a downward-facing surface of the antenna base 220.

The antenna assembly 100 may comprise a combination of at least one of the pucks 224, the feature 340, the support wall 350, and/or the shock absorber 500. For example, the antenna assembly 100 may include pucks 224 and the feature 340, but may not include the support wall 350 or the shock absorber 500. As another example, the antenna assembly 100 may include the support wall 350, the shock absorber 500, and the pucks 224, but may not include the feature 340. As yet another example, the antenna assembly 100 may include the pucks 224, the feature 340, the support wall 350, and the shock absorber 500.

The antenna assembly 100 of the present disclosure has various benefits. For example, the antenna assembly 100 may include at least one puck 224, the feature 340, the support wall 350, and/or the shock absorber 500. These attributes either used individually or in combination with each other may prevent the antenna 200 from being decoupled from the adapter plate 300 and/or from the moveable machine that it is attached to. Also, these attributes may prevent damage to the antenna 200 as compared to existing antenna assemblies.

### Conclusion

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An antenna assembly comprising:
an antenna comprising an antenna base, the antenna base comprising a plurality of pucks; and
an adapter plate configured to couple the antenna to a fuselage of an aircraft, the adapter plate defining a plurality of orifices,
wherein each puck is positioned within a respective orifice of the plurality of orifices.

2. The antenna assembly of claim 1, wherein each of the plurality of orifices extend completely through a thickness of the adapter plate.

3. The antenna assembly of claim 1, wherein each of the plurality of orifices have a circular cross-sectional shape.

4. The antenna assembly of claim 1, wherein each of the plurality of pucks have a hollow shape that is configured to receive a connector.

5. The antenna assembly of claim 1, wherein each of the plurality of pucks have a hollow shape that is configured to receive a Threaded Neill-Concelman (TNC) connector.

6. The antenna assembly of claim 1, wherein each orifice extends completely through a thickness of the adapter plate.

7. The antenna assembly of claim 1, wherein each puck extends a distance that is at least 90% of a thickness of the adapter plate.

8. The antenna assembly of claim 1, wherein the adapter plate comprises a feature at a forward end of the adapter plate, wherein the feature has a triangular cross-sectional shape.

9. The antenna assembly of claim 1, wherein the adapter plate comprises a support wall that extends upward from a main body of the adapter plate and is positioned aft of the antenna base.

10. The antenna assembly of claim 1, wherein the adapter plate comprises:
a feature at a forward end of the adapter plate, wherein the feature has a triangular cross-sectional shape; and
a support wall that extends upward from a main body of the adapter plate and is positioned aft of the antenna base.

11. An adapter plate configured to couple an antenna to a fuselage of an aircraft, the adapter plate comprising:
a feature at a forward end of the adapter plate, the feature configured to convert an otherwise blunt impact load into a slicing impact load.

12. The adapter plate of claim 11, wherein the feature is a razer edge or a knife edge.

13. The adapter plate of claim 11, wherein the feature has a triangular cross-sectional shape.

14. The adapter plate of claim 11, wherein the feature has a leading edge that is a forward-most portion of the feature and two sides that extend from the leading edge, and wherein an angle between the two sides is less than 90 degrees.

15. The adapter plate of claim 14, wherein the leading edge extends vertically.

16. An antenna assembly comprising:
an antenna; and
an adapter plate configured to couple the antenna to a fuselage of an aircraft, the adapter plate comprising:
a main body configured to receive the antenna; and
a support wall extending upward from the main body and configured to be aft of the antenna when the antenna is received by the main body.

17. The antenna assembly of claim 16, wherein the support wall extends around an aft end of the antenna at least 120 degrees.

18. The antenna assembly of claim 16, wherein the antenna comprises an antenna base, and wherein the support wall extends upward a distance that is at least half a height of the antenna base.

19. The antenna assembly of claim 16, wherein an inward-facing vertical surface of the support wall of the adapter plate has a shape that corresponds to an outward-facing vertical surface of the antenna.

20. The antenna assembly of claim 16, wherein:
the antenna comprises a plurality of pucks,
the adapter plate defines a plurality of orifices,
each puck of the antenna is positioned within a respective orifice of the plurality of orifices of the adapter plate, and
the adapter plate comprises a feature at a forward end of the adapter plate, wherein the feature has a triangular cross-sectional shape.
